(19) United States
(12) Patent Application Publication
(10) Pub. No.: US 2009/0121397 A1
(43) Pub. Date: May 14, 2009

(54) REDUCTION RETORT, REDUCTION RETORT MANUFACTURE METHOD, AND VACUUM SMELTING REDUCTION FURNACE USING THE SAME

(75) Inventors: Kui Ming Wong, Kowloon (CN); Jiqiang Zhang, Guizhou (CN)

Correspondence Address: MARTINE PENILLA & GENCARELLA, LLP, 710 LAKEWAY DRIVE, SUITE 200, SUNNYVALE, CA, 94085, US

(73) Assignee: MG Century Mining Corporation, Guiyang City (CN)

(21) Appl. No.: 12/352,564

(22) Filed: Jan. 12, 2009

Related U.S. Application Data
(63) Continuation of application No. PCT/CN2007/001856, filed on Jun. 12, 2007.

(30) Foreign Application Priority Data
Jul. 17, 2006 (CN) 200610200692.X
Jul. 21, 2006 (CN) 200610200710.4
Jul. 25, 2006 (CN) 200610200740.5
Aug. 15, 2006 (CN) 200610200800.3
Aug. 28, 2006 (CN) 200610200827.2
Aug. 28, 2006 (CN) 200610200830.4
Aug. 29, 2006 (CN) 200610200831.9
Nov. 14, 2006 (CN) 200610051274.9

(51) Int. Cl. C21B 7/00; C22B 3/02; B29C 69/00

(52) U.S. Cl. 266/171; 266/168; 264/241

(57) ABSTRACT

A reduction retort (11) for use in a vacuum smelting reduction furnace, including: a reducing portion (12) made of silicon carbide-based material; a condenser (13) disposed at one end of the reducing portion; an inlet closure (14) hermetically-connected to the condenser (13); and an outlet closure (15) disposed at the other end of the reducing portion (12), wherein the reduction retort (11) is disposed at an angle in the reduction furnace, with the end of the reduction retort (11) with the condenser (1 3) facing upward and the end of the reduction retort (11) with the outlet closure (15) facing downward. The reduction retort can save discharging time of spent residue, increase material load, enhance output, and improve heat utilization rate. The invention has a significantly prolonged service life in comparison to the conventional reduction retort made of nickel-chrome-steel alloy.

### CLAIM OF PRIORITY

This application claims priority under 35 U.S.C. §§ 120 and 365(c) as a continuation application of prior International Application PCT/CN2007/001856, which was filed on Jun. 12, 2007, and which was not published in English under PCT Article 21(2). The disclosure of the prior international application is incorporated herein by reference.

### TECHNICAL FIELD

The invention relates to a vacuum smelting apparatus and, more particularly, to a reduction retort and reduction furnace for smelting metal under reduced pressure.

### BACKGROUND ART

The structure of a conventional vacuum smelting reduction furnace is composed of, as shown in FIG. 1, a reduction retort 1, a condenser 2, and a chamber structure 3. The reduction retort 1 is horizontally disposed and supported by supports 4 & 5, wherein the end of the reduction retort 1 at where the condenser 2 is disposed is projected beyond the chamber structure 3, and the other end of the reduction retort 1, which is closed, is placed within the chamber structure 3. The charging of reactant material and the discharging of spent residue is carried out through the end of the reduction retort 1 at where the condenser 2 is disposed. The conventional reduction retort and the manner it is disposed in the reduction furnace is inconvenient for the charging and discharging processes. It is very labor-intensive and requires a lot of time and energy in production. It also has low fill rate and production output.

Furthermore, in the metal production process by vacuum smelting reduction method, after charging the reduction retort with the reactant material, depending on the type of metal and reducing agent used, the reduction reaction temperature is generally maintained between 1000 and 1200□ and the pressure is reduced to vacuum for the reduction reaction to take place. The reduction reaction temperature can be attained by heating the reduction retort with fuel or electricity. The conventional reduction retort is of a tubular structure. In the reduction process, heat is transferred from the inner wall of the reduction retort to the reactant material that is in direct contact with the wall. As for the reactant material that is not in direct contact with the inner wall of the reduction retort, heat is transferred thereto through radiation or from other reactant material through conduction. Because of the low thermal conductivity of the reactant material, it is apparent that the temperature of reactant material that is in direct contact with the inner wall of the reduction retort would be elevated much faster than the temperature of the reactant material that has to rely on the heat transfer from the reactant material next to them. Hence, it takes very long time for all the reactant material to reach the needed reduction reaction temperature. The reduction time, from the charging of material to the completion of reduction reaction, for metal production process by vacuum smelting reduction method using conventional reduction retort is generally between 6 and 15 hours. Obviously, long reduction time, low production efficiency and output, large energy wastage and high cost are the shortcomings of the conventional reduction retort.

Moreover, in the metal production process by vacuum smelting reduction method mentioned above, the internal pressure of the reduction retort is generally required to be less than 100 Pa. The metallic vapor constantly travels from the reactant material to the condenser during the reduction reaction process. Regional pressure may build up if the metallic vapor is trapped and accumulated within the reactant material pile. The build-up of the regional pressure to more than 100 Pa in the region where the reactant material are thickly piled will inhibit further reduction reaction from taking place, affecting the normal course of reduction reaction, and hence resulting in lower production output and wastage of energy.

Furthermore, the operating condition for a reduction retort in a metal production process by vacuum smelting reduction method is very severe, therefore refractory material is needed to make reduction retorts. However, heat-resisting metal that is resistant to higher temperature and suitable for long duration of use is very expensive. Conventionally, the general material used to make reduction retorts is heat resisting nickel-chrome-steel alloy that has a maximum working temperature of 1200□ under vacuum condition. This type of reduction retort has a short service life. It is easy to sustain damages like oxidation, creep, tear, etc. at high temperature. Therefore, large quantity of heat-resisting metal is needed to make a reduction retort, leading to high smelting cost. Not only is the need for constant turning and changing of such reduction retort very labor-intensive and time-consuming in production, it also leads to heat loss of the reduction furnace. Besides, the reduction time of metal production process by using such reduction retort, which has a maximum working temperature of 1200□, is significantly longer as compared to the reduction time of the same process carried outat a temperature much higher than 1200□.

### DISCLOSURE OF INVENTION

An object of the invention is to provide a reduction retort. The reduction retort can increase the charging speed of reactant material and the discharging speed of spent residue in a metal production process by vacuum smelting reduction method and effectively increase the fill rate of the reduction retort, whereby, the production efficiency and output of a reduction furnace is enhanced while the production cost is reduced.

Another object of the invention is to provide a reduction retort that is resistant to the oxidation, creep, and tear phenomenon at high temperature, that are easily incurred in the conventional reduction retort made by heat resisting nickel-chrome-steel alloy. As a result, the service life of the reduction retort is prolonged.

The invention discloses a reduction retort that is for use in a vacuum smelting reduction furnace. The reduction retort includes: a reducing portion made of silicon carbide-based material; a condenser disposed at one end of the reducing portion; an inlet closure hermetically-connected to the condenser; and an outlet closure at the other end of the reducing portion. The reduction retort is disposed at an angle in the reduction furnace, wherein the end of the reduction retort with the inlet closure is placed at a higher position and the other end of the reduction retort with the outlet closure is placed at a lower position.

One embodiment of the invention includes heat conductors, which are solidly bonded to the inner wall of the reducing portion of the reduction retort. The heat conductors increase the heat transfer from the wall of the reducing portion of the reduction retort to the reactant material during the metal production process by vacuum smelting reduction method, thereby shortens the reduction reaction time.

Another embodiment of the invention includes vapor passages provided inside the reducing portion of the aforementioned reduction retort to timely and quickly eliminate high metallic vapor pressure formed in some parts of the reduction retort, thereby shortens the time for reduction reaction. The metallic vapor could escape from the reactant material pile to the condenser by traveling along the vapor passages quickly.

Yet in another embodiment of the invention, the aforementioned reduction retort includes a heat-insulating plug provided inside the reduction retort above the outlet closure for reducing heat dissipation. Besides, the heat-insulating plug is used to hold the reactant material in the reducing portion of the reduction retort so that the reactant material stays within the chamber of the reduction furnace throughout a metal production process by vacuum smelting reduction method. In addition, heat-insulating portion(s) can be included between the reducing portion of the reduction retort and the condenser of the reduction retort, or(and) between the reducing portion of the reduction retort and the outlet closure, to minimize heat loss.

The invention also discloses a reduction retort manufacture method, which includes: forming a reducing portion of the reduction retort, the reducing portion being made of silicon carbide-based material; disposing a condenser at one end of the reducing portion; hermetically-connecting an inlet closure to the condenser; and disposing an outlet closure at the other end of the reducing portion.

The reduction retort is formed by mixing silicon carbide-based refractory material with 4% to 8 % of water and then casting in a mold. A reduction retort with reducing portion formed as such has strengthened resistance to compression, bending, and tension, and so its service life is prolonged while the usage and manufacture cost thereof are reduced.

The invention further discloses a vacuum smelting reduction furnace, which includes: an aforementioned reduction retort and a chamber structure. There are supports at the two sides of the chamber structure, wherein the support at one side of the chamber structure is higher than the support at the other side. The end of the reduction retort at where the condenser is disposed is placed on the higher support while the other end of the reduction retort with the outlet closure is placed on the lower support.

The invention solves the shortcomings found in conventional technology, these shortcomings including the small volume of reactant material being charged into the reduction retort, low metal output, and heavy workload for workers due to inconveniences in charging of reactant material and discharging of spent residue. The invention further exhibits other improvements, which are increased raw material fill rate in the reduction retort, shortened reduction time, enhanced production efficiency and output of the reduction furnace, and lowered production cost. The invention is applicable to metal production of magnesium, strontium, zinc, beryllium, and other metal that can be produced by vacuum smelting reduction method.

### BRIEF DESCRIPTION OF DRAWINGS

FIG. 1 is a schematic diagram illustrating a conventional reduction retort and its placement in a reduction furnace.

FIG. 2 is a schematic diagram illustrating a reduction retort and a vacuum smelting reduction furnace according to a first embodiment of the invention.

FIG. 3 is a schematic diagram illustrating a cross-sectional view of heat conductors provided inside a reducing portion of a reduction retort of the invention.

FIG. 4 is a schematic diagram illustrating a cross-sectional view of other heat conductors provided inside a reducing portion of a reduction retort of the invention.

FIG. 5 is a schematic diagram illustrating a cross-sectional view of yet other heat conductors provided inside a reducing portion of a reduction retort of the invention.

FIG. 6 is a schematic diagram illustrating a cross-sectional view of vapor passages provided inside a reducing portion of a reduction retort of the invention.

FIG. 7 is a schematic diagram illustrating a cross-sectional view of other vapor passages provided inside a reducing portion of a reduction retort of the invention.

FIG. 8 is a schematic diagram illustrating a cross-sectional view of yet other vapor passages provided inside a reducing portion of a reduction retort of the invention.

FIG. 9 is a schematic diagram illustrating a cross-sectional view of yet other vapor passages provided inside a reducing portion of a reduction retort of the invention.

FIG. 10 is a schematic diagram illustrating a cross-sectional view of yet other vapor passages provided inside a reducing portion of a reduction retort of the invention.

FIG. 11 is a schematic diagram illustrating an axial sectional view of a reduction retort according to a second embodiment of the invention. It includes a heat-insulating plug provided inside the reduction retort above an outlet closure of the reduction retort.

FIG. 12 is a schematic diagram illustrating a reduction retort according to a third embodiment of the invention. It includes heat-insulating portions each disposed between a reducing portion of the reduction retort and a condenser of the reduction retort, and between the reducing portion of the reduction retort and an outlet closure of the reduction retort.

FIG. 13 is a flow chart of a manufacture method of reduction retort according to the invention.

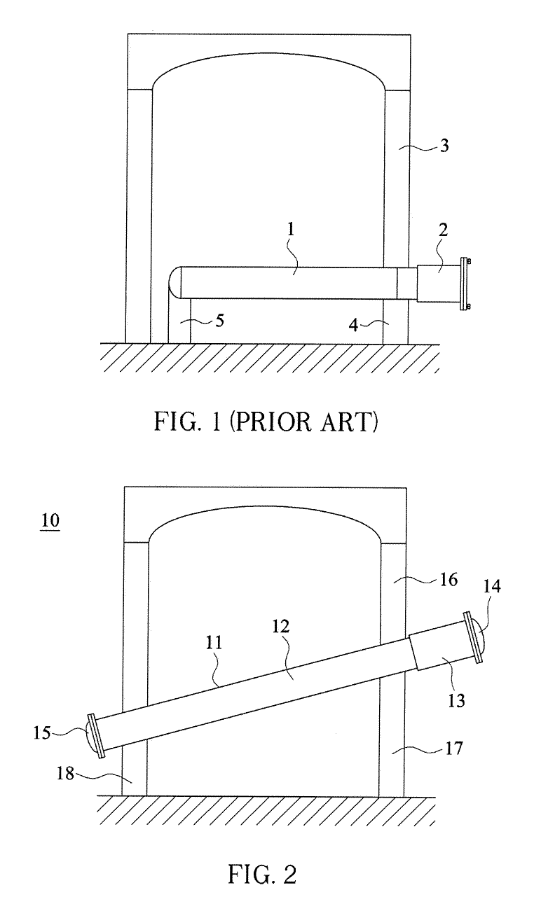

### BEST MODE FOR CARRYING OUT THE INVENTION

### First Embodiment

FIG. 2 illustrates a reduction retort 11 and a vacuum smelting reduction furnace 10 according to a first embodiment of the invention. The reduction furnace 10 includes a chamber structure 16 and the reduction retort 11. The chamber structure 16 includes a front support 17 and a back support 18 respectively disposed at the front end/side and the back end/side of the chamber structure 16, and the front support 17 is higher than the back support 18. The reduction retort 11 includes a reducing portion 12, a condenser 13, an inlet closure 14, and an outlet closure 15. The condenser 13 is disposed at one end of the reducing portion 12 and hermetically-connected with the inlet closure 14 while the outlet closure 15 is disposed at the other end of the reducing portion 12. The end of the reduction retort 11 at where the condenser 13 is disposed is placed on the front support 17 whereas the other end of the reduction retort 11 with the outlet closure 15 is placed on the back support 18. In other words, the reduction retort 11 is disposed at an angle in the reduction furnace 10, with the end of the reduction retort 11 at where the condenser 13 is disposed facing upward and the other end of the reduction retort 11 at where the outlet closure 15 is disposed facing downward. The inclination angle at which the reduction retort 11 is disposed is approximately 10° to 70°, and preferably 30° to 50°. It is to be noted that the condenser 13, the inlet closure 14, and the outlet closure 15 are projected beyond the chamber structure 16 as shown in FIG. 2.

The method of operation of the reduction retort 11 is described below. When reactant material needs to be charged for a vacuum smelting process, the inlet closure 14 is opened and reactant material is charged into the reduction retort 11 from the opening of the condenser 13. Since the reactant material could fall into the reduction retort 11 automatically due to self-weight, not only the workload for charging reactant material is lightened, the amount of charged reactant material for the reduction retort 11 is more than that for a horizontally disposed reduction retort. Thus, the fill rate of materials in the reduction retort is increased and it is easier to manage the volume of reactant material charged into the reduction retort; these factors are good for the realization of a complete reduction reaction and subsequently the heat utilization rate is increased. After the material is added, the inlet closure 14 is closed hermetically and a reduction reaction is carried out. After the reaction is complete, the outlet closure 15 is opened to remove spent residue. Since the outlet closure 15 is facing downward with an angle, the spent residue, due to self-weight, is very easily removed out of the reduction retort 11, resulting in a decrease in workload. Therefore, in comparison to conventional technology, the invention can increase the charging speed of the reactant material and the discharging speed of the spent residue in the metal production process by vacuum smelting reduction method, effectively increase the fill rate in the reduction retort, and in turn enhance the production efficiency and output of the reduction furnace with reduced production cost.

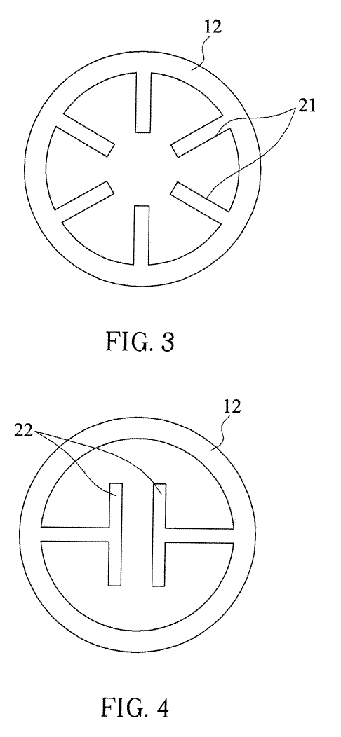

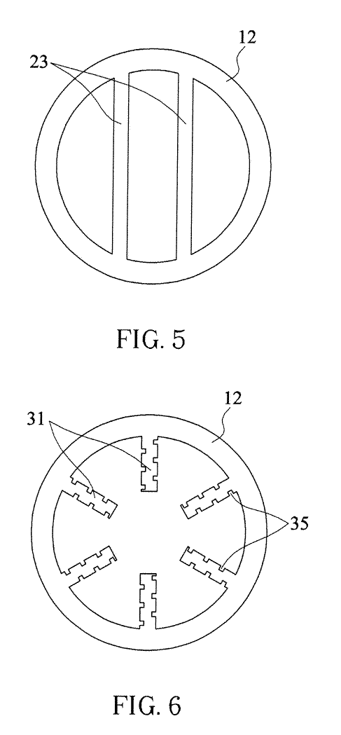

In order to improve deficiencies of conventional technology—long heating time for reduction reaction, low production efficiency and output per unit time, large consumption of energy, and high production cost, heat conductors are introduced in another embodiment of the invention. The heat conductors are provided inside the reducing portion 12 of the aforementioned reduction retort 11 and are solidly bonded to the inner wall of the reduction retort 11. The solid bonding is achieved by casting the heat conductors and the reducing portion 12 of the reduction retort 11 in a single mold. The aforementioned heat conductors can be any shape and in any arrangement so long as heat conduction effect is enhanced. For example, as shown in FIGS. 3, 4, and 5, heat conductors 21, 22, and 23 bonded to the inner wall of the reducing portion 12 are respectively in a radial arrangement structure, a T-shaped structure, and a parallel arrangement structure. For a best heat conduction effect, the shape and arrangement of the heat conductors are such that the furthest distance between any reactant material and the closest heat conductor or the closest wall of the reducing portion 12 should not exceed 15 cm, and more preferably, 10 cm. Comparing to conventional technology, this embodiment of the invention greatly increases the heating speed of reactant material in the reduction retort 11, enhances the production efficiency and output, lowers energy consumption, and reduces production cost, by disposing heat conductors in the reduction retort 11.

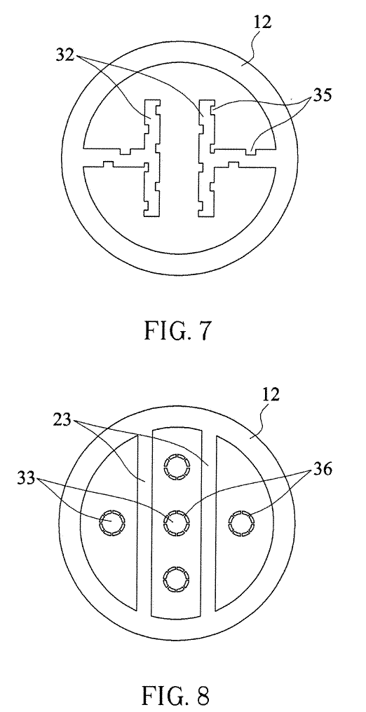

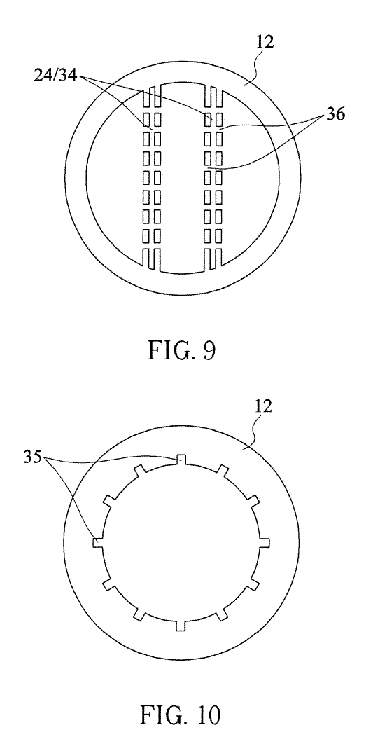

In yet another embodiment of the invention, vapor passages are provided in the reducing portion 12 of the aforementioned reduction retort 11, for timely and quickly elimination of high metallic vapor pressure formed in some parts of the reduction retort 11 during a reduction reaction process, whereby the metallic vapor travels along the vapor passages and escapes to the condenser 13. The aforementioned vapor passages can be any structure and in any form that is suitable for gases to flow through quickly. For example, the vapor passages can be radially-arranged structures 31 having grooves 35 or T-shaped structures 32 having grooves 35 as shown in FIGS. 6 and 7, respectively. The vapor passages can also be grooves 35 on the inner wall of the reducing portion 12 as shown in FIG. 10, or it can also be tubes 33 having through holes 36 or chamber-shaped structures 34 having through holes 36 as shown in FIGS. 8 and 9, respectively. Moreover, the aforementioned types of vapor passages can be formed in the reducing portion 12 of the reduction retort 11 together with the heat conductors of the aforementioned embodiment (as shown in FIG. 8), or can function as heat conductors themselves (as shown in FIG. 9). Therefore, the vapor passages can also be formed as heat conductors having grooves, heat-conducting chamber-shaped structures having through holes, or heat-conducting tubes having through holes.

In addition, the width of the aforementioned grooves and the diameter of the aforementioned through holes are preferably smaller than the briquette size of the reactant material as to prevent the reactant material from entering the grooves or the through holes. Furthermore, for an effective elimination of high metallic vapor pressure formed at some parts of the reduction retort, the shape and arrangement of the aforementioned vapor passages should be such that the distance between any reactant material and the closest groove, or the closest through hole, is not greater than 15 cm, and preferably, 10 cm. In comparison with conventional technology, this embodiment can timely and effectively eliminate regional pressure formed by the metallic vapor escaped from the reactant material in the reduction reaction, guaranteeing a normal and continuous course of the reduction reaction. As a result, the production efficiency and output per unit time are increased while the energy consumption and the production cost are lowered.

### Second Embodiment

In general, reduction retorts are worked under a condition of a temperature over 1000□ and an internal pressure less than 110 Pa. If the reactant material at the outlet end of the reduction retort resides outside of the chamber of reduction furnace, not only would the heat in the reduction retort be transferred out of the chamber, but a part of the reactant material would not subject to direct heating in the chamber. Consequently, the required reduction reaction temperature cannot be reached, and the normal course of the reaction is affected, causing a waste of the reactant material and energy. The inventor improved the aforementioned reduction retort of first embodiment to solve this problem.

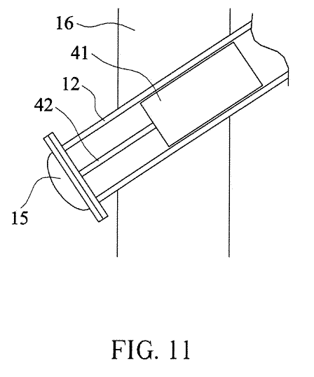

FIG. 11 is a schematic diagram illustrating a reduction retort according to a second embodiment of the invention. The structure of this reduction retort is similar to the reduction retort of the first embodiment, wherein the difference is that a heat-insulating plug 41 for heat insulating purpose is provided in the reduction retort of this embodiment. The heat-insulating plug 41 is provided inside the reducing portion 12 above the outlet closure 15, for reducing heat loss in the reduction retort and holding the reactant material in the reducing portion 12 of the reduction retort. The reactant material therefore stays within the chamber of the reduction furnace during a reduction process and thus can be directly heated in the chamber to reach a suitable reaction temperature. The heat-insulating plug 41 is of a piston shape and it can be supported in the reducing portion 12 by a rod 42. For a better heat insulation effect, the thickness of the heat-insulating plug 41 should be more than 5 cm and the heat-insulating plug 41 should be made of refractory heat-insulating material.

In this embodiment, a heat-insulating plug is provided in the reducing portion above the outlet closure, and thereby the heat loss in the reduction retort is greatly reduced while the reactant material at the outlet end of the reduction retort is held to stay within the chamber of the reduction furnace and subjected to direct heating. Thus energy consumption and production cost are reduced.

### Third Embodiment

In the aforementioned first and second embodiments, if the portion of the reduction retort that is exposed outside the chamber of a reduction furnace is made of the same high heat-conducting material as the portion of the reducing portion that is retained within the chamber, heat in the chamber would be massively transferred out, affecting the reduction reaction. In addition, the transferred heat would increase the difficulty of hermetic sealing between the reduction retort and outlet closure, which are at high temperature. The inventor made further improvements to the reduction retort mentioned above to solve this problem.

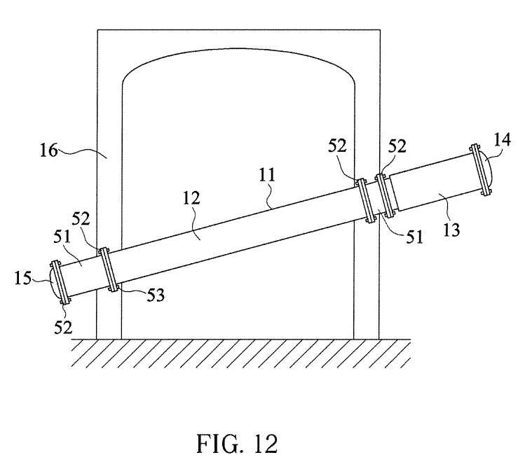

FIG. 12 is a schematic diagram illustrating a reduction retort according to a third embodiment of the invention. The structure of this reduction retort is similar to the structure of the reduction retort of the first embodiment, wherein the difference is that two heat-insulating portions 51 are provided in the reduction retort 11 of this embodiment. The heat-insulating portions 51 are disposed between the reducing portion 12 and the condenser 13, as well as between the reducing portion 12 and the outlet closure 15 respectively, and are both disposed outside of the chamber of the reduction furnace. The couplings between the heat-insulating portion 51 and the reducing portion 12, and the condenser 13, and the outlet closure 15, are composed of flanges 52, which are fastened through bolts 53 wrapped in heat-insulating pads or heat-insulating tubes. The heat-insulating portion 51 is made of refractory heat-insulating material. For example, it is cast with corundum preparation or corundum cast material, aluminum oxide hollow sphere cast material, mullite hollow sphere cast material, or zirconia hollow sphere cast material, or made with ceramic fiber material. Moreover, in order to attain hermetic sealing, a refractory sealing material (not shown), such as graphite or refractory cotton, is placed/inserted between the reducing portion 12 and the heat-insulating portion 51, between the heat-insulating portion 51 and the condenser 13, and between the heat-insulating portion 51 and the outlet closure 15.

In this embodiment, since the heat-insulating portions are separately disposed between the reducing portion and the condenser, and between the reducing portion and the outlet closure, the heat loss in the chamber of the reduction furnace is greatly reduced, solving the high temperature hermetic sealing problem. Consequently, the energy consumption and the production cost are reduced.

The reducing portion of the reduction retort of the aforementioned embodiments can be made of any refractory heat-conducting material such as refractory alloy steel. Particularly, it can be prepared with silicon carbide-based material, the use of which improves the oxidation, creep and tear phenomenon that easily occur, at high temperature, in conventional reduction retorts made of heat resisting nickel-chrome-steel alloy. The silicon carbide-based material can be a silicon carbide-based refractory cast material having a composition of 85 to 98 weight percentage of silicon carbide-based raw material, 2 to 15 weight percentage of aluminate cement, and 0.05 to 1.0 weight percentage of water reducing agent. The reduction retort with silicon carbide reducing portion has much better resistance to compression, bending, and tension, which helps in prolonging its service life, and in turn the problems originated from the frequent needs to turn or change retorts are solved. A reduction retort with silicon carbide reducing portion can work and be operated at above 1200□ but under 1500□, a temperature range which is high enough to shorten the reduction time, leading to a decrease in the cost and the usage of reduction retorts.

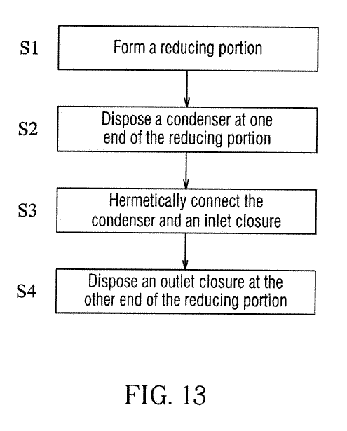

A manufacture method of reduction retort of the invention is as shown in FIG. 13. Firstly, a reducing portion is formed (S1). The reducing portion can be made of any refractory heat-conducting material, for example, heat-resisting alloy steel, which is generally melted before being poured into a mold for casting. The reducing portion can also be prepared with silicon carbide as the basic material, to improve the resistance to oxidization, creep and tear phenomenon, which are easily incurred by conventional retort material, heat resisting nickel-chrome-steel alloy, at high temperature. This silicon carbide reducing portion is formed by: mixing silicon carbide-based refractory cast material with 4% to 8% of water, followed by pouring the mixture into a mold for casting, and then curing to obtain the prepared product. The silicon carbide-based refractory cast material has a composition of 85 to 98 weight percentage of silicon carbide-based raw material, 2 to 15 weight percentage of aluminate cement, and 0.05 to 1.0 weight percentage of water reducing agent like sodium hexametaphosphate or sodium tripolyphosphate. The silicon carbide (SiC) content in the silicon carbide-based raw material is greater than or equal to 90% while the aluminum oxide (Al₂O₃) content in the aluminate cement is greater than or equal to 55%.

Secondly, a condenser is disposed at one end of the reducing portion (S2), and then the condenser is hermetically-connected with an inlet closure (S3). Finally, an outlet closure is disposed at the other end of the reducing portion (S4) to complete the making of a reduction retort. It is to be noted that flanges are used to couple the condenser and the reducing portion, the inlet closure and the condenser, and the outlet closure and the reducing portion.

The manufacture method of reduction retort mentioned above is just a general description; the steps can be varied according to acquired functions of the reduction retort. For instance, if the speed at which reactant material in the reduction retort is heated is to be increased, heat conductors can be provided inside the reducing portion and solidly bonded to the inner wall of the reducing portion. Also, if the high metallic vapor pressure formed regionally in the reduction retort is to be eliminated, vapor passages can be provided inside the reducing portion of the reduction retort so that the metallic vapor can escape from the reducing portion along the vapor passages to the condenser. As well, if the heat loss in the reduction retort is to be minimized, a heat-insulating plug can be provided inside the reducing portion above the outlet closure, for holding the reactant material in the reduction retort so that the reactant material stays within the chamber of the reduction furnace throughout the entire reduction process. In addition, at least one heat-insulating portion can be disposed between the reducing portion and the condenser, and/or between the reducing portion and the outlet closure, for reducing heat loss.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretations so as to encompass all such modifications and similar arrangements.

### INDUSTRIAL APPLICABILITY

The invention discloses a reduction retort with specially arranged heat conductors solidly bonded to the inner wall of the reduction retort, vapor passages, and heat-insulating plug to increase heating speed and reduce heat dissipation, and in turn the reduction reaction time is shortened. The reduction retort is further disposed at an angle in a reduction furnace, whereby making the charging of material and discharging of spent residue more convenient for workers. Hence, the production efficiency and output of the reduction furnace are enhanced while the production cost is lowered.

What is claimed is:

1. A reduction retort, which is for use in a vacuum smelting reduction furnace, comprising:
a reducing portion made of silicon carbide-based material;
a condenser disposed at one end of the reducing portion;
an inlet closure hermetically-connected to the condenser; and
an outlet closure disposed at the other end of the reducing portion;
wherein the reduction retort is disposed at an angle in the reduction furnace, with the end of the reduction retort at where the condenser is disposed facing upward and the other end of the reduction retort at where the outlet closure is disposed facing downward.

2. The reduction retort as described in claim 1, wherein the condenser, the inlet closure, and the outlet closure are located outside of the chamber structures of the reduction furnace.

3. The reduction retort as described in claim 1, wherein the angle at which the reduction retort is disposed is 10° to 70°.

4. The reduction retort as described in claim 1, wherein the angle at which the reduction retort is disposed is 30° to 50°.

5. The reduction retort as described in claim 1, wherein heat conductors are provided inside the reducing portion and are solidly bonded to the inner wall of the reducing portion.

6. The reduction retort as described in claim 5, wherein the solid bonding is achieved by casting the reducing portion and the heat conductors in a single mold.

7. The reduction retort as described in claim 5, wherein the shape and arrangement of the heat conductors are such that the furthest distance between any reactant material and the closest heat conductor, or the closest wall of the reducing portion does not exceed 15 cm.

8. The reduction retort as described in claim 5, wherein the shape and arrangement of the heat conductor are such that the furthest distance between any reactant material and the closest heat conductor, or closest wall of the reducing portion does not exceed 10 cm.

9. The reduction retort as described in claim 1, wherein vapor passages of metallic vapor is provided inside the reducing portion, through which metallic vapor escapes to the condenser.

10. The reduction retort as described in claim 9, wherein the vapor passages of metallic vapor is provided in a form of grooves on the inner wall of the reducing portion, structures having grooves, a chamber-shaped structures having through holes, or tubes having through holes.

11. The reduction retort as described in claim 9, wherein the vapor passages of metallic vapor is provided in a form of heat conductors having grooves, heat-conducting chamber-shaped structures having through holes, or heat-conducting tubes having through holes.

12. The reduction retort as described in claim 10 or 11, wherein the width of the guiding grooves and the diameter of the through holes are smaller than the briquette size of reactant material.

13. The reduction retort as described in claim 10 or 11, wherein the shape and arrangement of the vapor passages are such that the distance between any reactant material and the closest groove, or the closest through hole, does not exceed 15 cm.

14. The reduction retort as described in claim 10 or 11, wherein the shape and arrangement of the vapor passages are such that the distance between any reactant material and the closest groove, or the closest through hole, does not exceed 10 cm.

15. The reduction retort as described in claim 1, wherein a heat-insulating plug is provided inside the reducing portion above the outlet closure, for holding reactant material in the reduction retort within the chamber of the reduction furnace during a reduction process.

16. The reduction retort as described in claim 15, wherein the heat-insulating plug is in a piston shape.

17. The reduction retort as described in claim 15, wherein a rod is provided inside the reducing portion, for supporting the heat-insulating plug.

18. The reduction retort as described in claim 15, wherein the thickness of the heat-insulating plug is not less than 5 cm.

19. The reduction retort as described in claim 15, wherein the heat-insulating plug is made of refractory heat-insulating material.

20. The reduction retort as described in claim 1, wherein at least one heat-insulating portion is disposed between the reducing portion and the condenser, and/or between the reducing portion and the outlet closure.

21. The reduction retort as described in claim 20, wherein the heat-insulating portion is disposed outside of the chamber of the reduction furnace.

22. The reduction retort as described in claim 20, wherein flanges are used to couple the heat-insulating portion and the reducing portion, the heat-insulating portion and the condenser, and the heat-insulating portion and the outlet closure.

23. The reduction retort as described in claim 22, wherein the flanges are fixed by bolts covered with heat-insulating pads or heat-insulating tubes.

24. The reduction retort as described in claim 20, wherein the heat-insulating portion is made of refractory heat-insulating material.

25. The reduction retort as described in claim 24, wherein the heat-insulating portion is made by casting material of corundum preparation or corundum, aluminum oxide hollow sphere, mullite hollow sphere, or zirconia hollow sphere, or made with ceramic fiber material.

26. The reduction retort as described in claim 20, wherein refractory sealing material is inserted between the heat-insulating portion and the reducing portion, between the heat-insulating portion and the condenser, and between the heat-insulating portion and the outlet closure.

27. The reduction retort as described in claim 26, wherein the refractory sealing material is graphite or refractory cotton.

28. The reduction retort as described in claim 1, wherein the reducing portion is a silicon carbide-based refractory cast material having a composition of 85 to 98 weight percentage of silicon carbide-based raw material, 2 to 15 weight percentage of aluminate cement, and 0.05 to 1.0 weight percentage of water reducing agent.

29. The reduction retort as described in claim 28, wherein the silicon carbide-based raw material has a silicon carbide (SiC) content greater than or equal to 90%, and the aluminate cement has an aluminum oxide (Al₂O₃) content greater than or equal to 55%.

30. A reduction retort manufacture method comprising the steps of:
forming a reducing portion made of silicon carbide-based material;
disposing a condenser at one end of the reducing portion;
hermetically-connecting an inlet closure to the condenser; and
disposing an outlet closure at the other end of the reducing portion.

31. The reduction retort manufacture method as described in claim 30, wherein the forming step comprises:
mixing silicon carbide-based refractory cast material with 4% to 8% of water; and
pouring the mixture into a mold for casting.

32. The reduction retort manufacture method as described in claim 31, wherein the silicon carbide-based refractory cast material is prepared with, by weight, 85% to 98% of silicon carbide-based raw material, 2% to 15% of aluminate cement, and 0.05% to 1.0% of water reducing agent.

33. The reduction retort manufacture method as described in claim 32, wherein the content of silicon carbide in the silicon carbide-based raw material is greater than or equal to 90%, and the content of aluminum oxide in the aluminate cement is greater than or equal to 55%.

34. The reduction retort manufacture method as described in claim 30, further comprising the step of:
providing heat conductors inside the reducing portion and solidly bonding the heat conductors to the inner wall of the reducing portion.

35. The reduction retort manufacture method as described in claim 30, further comprising the step of:
providing vapor passages inside the reducing portion, through which metallic vapor escapes to the condenser.

36. The reduction retort manufacture method as described in claim 30, further comprising the step of:
providing a heat-insulating plug inside the reducing portion above the outlet closure, for holding reactant material in the reduction retort within the chamber of a reduction furnace during a reduction process.

37. The reduction retort manufacture method as described in claim 30, further comprising the step of:
providing at least one heat-insulating portion between the reducing portion and the condenser and/or between the reducing portion and the outlet closure.

38. A vacuum smelting reduction reduction furnace, comprising:
a reduction retort as described in claim 1; and
a chamber structure, which has at least two supports respectively provided at each of the two sides of the chamber structure, and the support at one side is higher than the support at the other side;
wherein the end of the reduction retort with the condenser is placed on the higher support, and the end of the reduction retort with the outlet closure is placed on the lower support.
